(19) United States
(12) Patent Application Publication
(10) Pub. No.: US 2002/0146147 A1
(43) Pub. Date: Oct. 10, 2002

(54) Digitally watermarking physical media

(76) Inventor: Kenneth L. Levy, Stevenson, WA (US)

Correspondence Address: DIGIMARC CORPORATION, 19801 SW 72ND AVENUE, SUITE 100, TUALATIN, OR, 97062, US

(21) Appl. No.: 09/940,873

(22) Filed: Aug. 27, 2001

Related U.S. Application Data
(60) Provisional application No. 60/282,205, filed on Apr. 6, 2001.

(51) Int. Cl. G06K 9/00

(52) U.S. Cl. 382/100

(57) ABSTRACT

A digital watermark is embedded within a two-dimensional visual design on a CD, SACD or DVD. A pattern of pits or data indentations forms the visual design. The watermark is embedded by slightly varying various pit locations within the visual design. The digital watermark is used as a counterfeit deterrent and as an identifier. Once extracted, the identifier is used to link to related content via the internet.

### RELATED APPLICATION DATA

This application claims the benefit of U.S. Provisional Application No. 60/282,205, filed Apr. 6, 2001. This application is related to U.S. Patent Application Nos. 09/503,881, filed Feb. 14, 2000 and No. 09/924,402, filed Aug. 7, 2001.

### FIELD OF THE INVENTION

The present invention generally relates to digital watermarking and, more particularly, relates to digitally watermarking physical media such as CDs, DVDs, SACDs, mini-CDs, etc.

### BACKGROUND AND SUMMARY OF THE INVENTION

It's not as easy to spot a pirate as it used to be. The first time you laid eyes on Captain Hook you knew you were dealing with a pirate. Maybe it was the black flag. Maybe it was his motley crew. Now times have changed. Today pirates wear finely tailored suits. Or they lurk in a manufacturing facility in their garage. Yet a common thread binds today's pirates to their historic comrades—they seek to profit from other people's work and creativity. They remain common thieves.

Pirates (including counterfeiters and bootleggers) annually rob industry in the order of tens of billions. These losses are projected to double in the near future, particularly in today's digital world. Compact discs (CDs), digital versatile discs (DVDs) and other recording media are easy prey. They can be massively reproduced with over-the-counter computer equipment. Similarly, media packaging (e.g., art jackets or labels) is easily counterfeited using sophisticated, yet low-cost printers.

The consumer bares the brunt of counterfeiting and piracy. Many consumers purchase sub-par goods thinking that they are genuine. Consumers who purchase counterfeit DVDs or CDs can end up with low fidelity products or blank tracks.

A solution is needed to effectively combat piracy.

Digital watermarking provides a solution. Digital watermarking technology, a form of steganography, encompasses a great variety of techniques by which plural bits of digital data are hidden in some other object, preferably without leaving human-apparent evidence of alteration.

Digital watermarking may be used to modify media content to embed a machine-readable code into the media content. The media may be modified such that the embedded code is imperceptible or nearly imperceptible to the user, yet may be detected through an automated detection process.

Most commonly, digital watermarking is applied to media signals such as images, audio, and video signals. However, it may also be applied to other types of media, including documents (e.g., through line, word or character shifting, texturing, graphics, or backgrounds, etc.), software, multi-dimensional graphics models, and surfaces of objects.

There are many processes by which media can be processed to encode a digital watermark. Some techniques employ very subtle printing, e.g., of fine lines or dots, which has the effect slightly tinting the media (e.g., a white media can be given a lightish-green cast). To the human observer the tinting appears uniform. Computer analyses of scan data from the media, however, reveals slight localized changes, permitting a multi-bit watermark payload to be discerned. Such printing can be by ink jet, dry offset, wet offset, xerography, etc. Other techniques vary the luminance, color qualities, or gain values in a signal to embed a message signal. The literature is full of well-known digital watermarking techniques.

The encoding of a label (or non-data CD side) can encompass artwork or printing on the label, the label's background, a laminate layer applied to the label, surface texture, etc. If a photograph, graphic or image is present, it too can be encoded.

Digital watermarking systems typically have two primary components: an embedding component that embeds the watermark in the media content, and a reading component that detects and reads the embedded watermark. The embedding component embeds a watermark pattern by altering data samples of the media content. The reading component analyzes content to detect whether a watermark pattern is present. In applications where the watermark encodes information, the reading component extracts this information from the detected watermark. Previously mentioned U.S. patent application Ser. No. 09/503,881, filed Feb. 14, 2000, discloses various encoding and decoding techniques. U.S. Pat. Nos. 5,862,260 and 6,122,403 disclose still others. Artisans know many other watermarking techniques.

One form of digital watermarks is a so-called “fragile” watermark. A fragile watermark is designed to be lost, or to degrade predictably, when the data set into which it is embedded is processed in some manner, such as signal processing, compression scanning/printing, etc. A watermark may be made fragile in numerous ways. One form of fragility relies on low watermark amplitude. That is, the strength of the watermark is only marginally above the minimum needed for detection. If any significant fraction of the signal is lost, as typically occurs in photocopying operations, the watermark becomes unreadable. Another form of fragility relies on the watermark's frequency spectrum. High frequencies are typically attenuated in the various sampling operations associated with digital scanning and printing. Even a high amplitude watermark signal can be significantly impaired, and rendered unreadable, by such photocopying operations. (Fragile watermark technology and various applications of such are even further disclosed, e.g., in assignee's U.S. patent application Ser. Nos. 09/234,780, 09/433,104, 09/498,223, 60/198,138, 09/562,516, 09/567,405, 09/625,577, 09/645,779, and 60/232,163.).

Commonly assigned U.S. Provisional Patent No. 60/282,205 discloses methods and systems to protect media such as VHS tapes, CDs, DVDs, etc. Media packaging or labels can be embedded with a digital watermark. The digital watermark is used as an identifier to facilitate asset management. Or the watermark can be used to control or regulate access to the media content. In one embodiment, a user shows the packaging or label side of the CD to a digital camera to link to the internet. In another embodiment, the digital watermark is used to verify authenticity of the CD.

Commonly assigned U.S. patent application Ser. No. 09/924,402 discloses an inspector network, which allows an inspector to efficiently detect counterfeited goods via a digital watermark identifier.

There is room in the art for additional counterfeit-deterring methods and techniques. Consider pirates who counterfeit product packaging (including labels) and then apply them to illegal media copies. Unless a fragile watermark is embedded in the original packaging, or unless the packaging is uniquely identified with a watermark identifier or metadata, a pirate can successfully counterfeit even some types of digitally watermarked packaging.

An object of the present invention is to provide a digital watermark that offers additional anti-counterfeiting protection. The inventive digital watermark includes visible effects of a digital optical storage media. Digital optical storage media includes CDs, DVDs (audio or video), Super Audio CDs (“SACDs”), laser discs, mini-discs, CD2s and all similar technology. For simplicity such media is referred to as a CD.

An advantage of the present invention is that such a digital watermark is inherently difficult to copy by common recording CD devices and illegitimate production masters used in the mass production of counterfeited CDs. In one embodiment, the inventive digital watermark helps content owners find illegal CD counterfeits, either at the distributor, retailer or user location. In another embodiment, the inventive digital watermark allows an authentic watermarked CD to link via a network to additional content via the watermark—a distinct consumer advantage over counterfeited media. This method is cost effective since the process adds little or no production costs to individual CDs, and only minimal cost to the process of creating the original CD master. Once the glass master is created, each replica CD includes the watermark.

The foregoing and other features and advantages of the present invention will be more readily apparent from the following detailed description, which proceeds with reference to the accompanying drawings.

### BRIEF DESCRIPTION OF THE DRAWINGS

FIG. 1 is a block diagram showing a visual design watermarking method.

FIG. 2 is a diagram showing pit-deviations in a CD track segment according to one embodiment of the present invention.

FIG. 3 is a diagram showing the image capture of a CD.

FIG. 4 is a diagram showing a network that is navigable with a CD identifier.

### DETAILED DESCRIPTION

The present invention creates an imperceptible digital watermark on a CD surface through “pit” manipulation (or placement). Preferably, the digital watermark is arranged on the signal (or data) side of a CD. A pit is a small indentation (or other structure) in a CD surface that is used to convey data. Pits are often visually discernable. According to the present invention, an imperceptible digital watermark is embedded in a visually perceptible CD bit pattern—much like watermarking a 2-dimensional image.

Pit alignment (or placement) has been used to create “visible” watermarks as demonstrated with Super Audio CDs (“SACDs”). Our inventive digital watermark is embedded within this visible watermark or design. To simplify the terminology used herein a SACD-like “visible watermark” will be referred to hereafter as a “visual design” (or “pit-pattern”). As will be appreciated, SACD is a high-density disc format that uses a proprietary audio system developed by Philips and Sony. Like the DVD, SACD has high capacity used to achieve a high-quality, multi-channel surround sound. SACDs can be manufactured to include slight variations in their data encoding (or bit placement) to create a visible design effect on the data (or signal) side of an SACD. This visual design is physically implemented into the surface of SACD discs during the replication process using the known Pit Signal Processing (PSP) technology.

The SACD format provides additional security measures including SACD's own “invisible” watermark, which is stored separately to the data on the disc to prevent reading by non-compliant devices such as DVD-ROM drives. This invisible watermark is encoded (or stored) separately in a Direct Stream Digital (DSD) bit stream. In other words, the SACD invisible watermark resides in the data, not in the visible design.

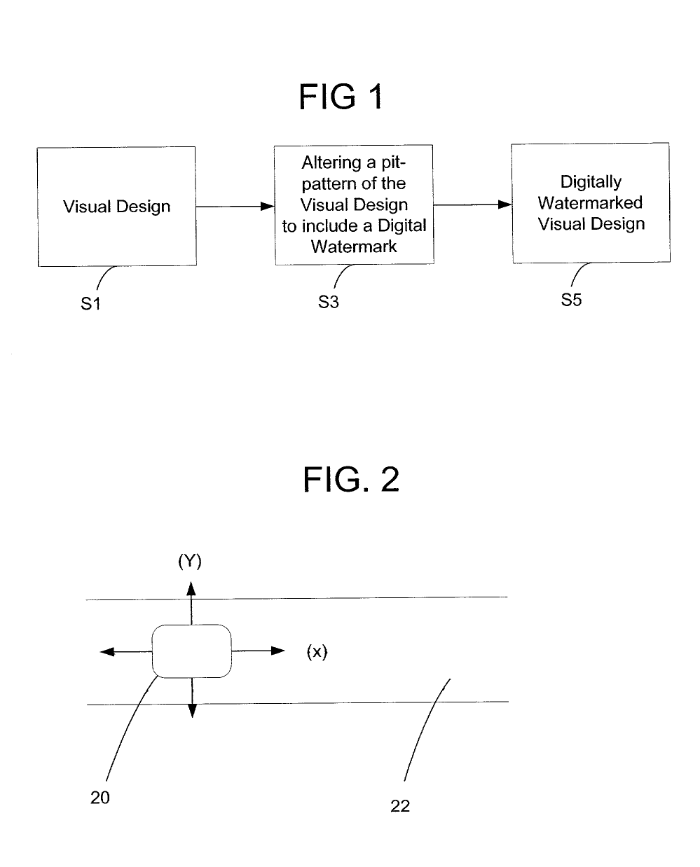

My inventive digital watermark is embedded in a visual design on a CD. Preferably, my watermark signal (e.g., a pseudo-random noise (PN) sequence) is implemented by slight adjustments to the pit-pattern of the visual design. Since digital watermarks use deviations that are not readily visible to the human eye, but are discemable to watermark detection software, the watermark embedding process preferably does not cause data-read errors in the CD. In one embodiment, with reference to FIG. 1, a visual design is created (S1). The pit-pattern of the visual design is varied so as to embed a digital watermark signal therein (S3). A digitally watermarked visual design results (S5). This watermarked visual design can then be transferred to a CD master to enable production of the digitally watermarked CDs In other embodiments, a digital watermark and visual design are concurrently determined. In still other embodiments, the watermark signal is used as the visual design.

Some CD tracking techniques include rings running parallel with the pits. These parallel ring tracks provide more latitude in moving a pit (20) in a track (22) circumference (x direction) as opposed to up and down, e.g., toward the edge or center of a CD (y direction). (See FIG. 2, which show a CD track segment including a pit.). In this case, moving a pit location slightly counter-clockwise could to represent a digital 1. Or moving a pit location slightly clockwise could represent a digital 0, or visa-versa. Of course other techniques can be used to similarly adjust pit-locations to embed a digital watermark, such as offsetting a pit location, elongating (or shortening) a pit indentation, pseudo-randomly deviating pit-locations, etc.

A pirated copy of a digitally watermarked CD will not include the digital watermark since the pirated copy will not readily include the pit-pattern. Common CD recording devices (e.g., CD-Rom burners) copy only 1's and 0's—not the visual design or embedded watermark formed by data pits. It is extremely difficult to counterfeit a glass master so as to include a likelihood of breaking the original's watermark encoding and/or encryption techniques as carried by a pit-pattern. This is particularly true since a watermark protocol, e.g., including a PN sequence, is preferably kept secret by content owners. In addition, CD production equipment, capable of creating visual designs, is far more expensive than a standard CD-Rom burner—creating a significant barrier to entry for the common pirate.

Identical pit deviations can be included in every CD copy made on mass-production equipment. In this case, each watermark includes the same identifier. Alternatively, the pit deviations may be changed for each CD to create a unique CD serialization. CD serialization allows each CD to be traced. In one embodiment, a watermark payload per each individual CD includes a common ID (e.g., to identify media title, manufacture, batch run number, date produced, copyright owner, etc.). Similarly, the watermark payload preferably includes a count (or individual CD identifier). The common ID is used for linking, as described below, and the count is used for forensic tracking of each CD.

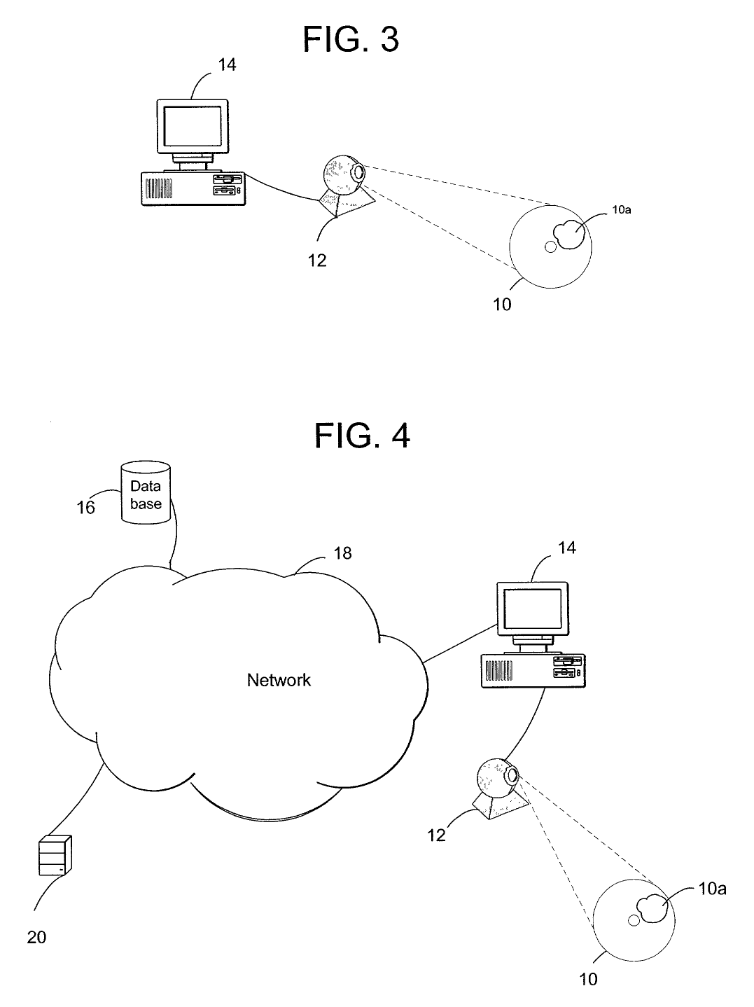

With reference to FIG. 3, a CD 10 is presented to an input device 12, such as a digital camera, web camera, optical sensor, etc. CD 10 preferably includes a visual design 10a located on a data side of CD 10. Visual design 10a preferably includes a digital watermark embedded therein. (Of course, a non-data CD side may include text, graphics, artworks, images, etc., which may be embedded with a digital watermark. This watermark can be compared to the watermark embedded in the visual design, or can be used as a separate or additional identifier or security check.). Input device 12 captures an image of the digitally watermarked visual design 10a. This captured image is communicated to computer 14. Of course, input device 12 can be tethered to computer 14 (as shown) or can otherwise interface with computer 14. Alternatively, input device 12 wirelessly communicates with computer 14, e.g., via Bluetooth. Computer 14 preferably includes watermark detection and decoding software instructions stored in memory to be executed on computer 14's processor and/or processing circuitry. Computer 14 executes these software instructions to analyze the captured CD image. The embedded watermark signal is detected from such. In some embodiments, the digital watermark includes a payload or message. Computer 14 preferably extracts the watermark payload from the captured image if present. Computer 14 need not be desktop device as illustrated in FIG. 3. To the contrary computer, 14 can include a handheld device, a laptop, a server system, etc.

In one embodiment, with reference to FIG. 4, computer 14 communicates the extracted watermarked ID to a database (and router) 16. Database 16 is preferably accessible via a network 18 (e.g., internet, intranet, extranet, wireless network, LAN, WAN, etc.). Alternatively, database 16 is local with respect to computer 14. Database 16 communicates information (e.g., a URL, web address, e-mail address, IP address, etc.) to computer 14 to redirect computer 14 to a web site 20. Assignee's U.S. patent application Ser. No. 09/571,422, filed May 15, 2000, discloses related linking methods and apparatus.

Web site 20 preferably includes accessible content related to CD 10, such as information about the music, artist, song, movie, actors, content, data, software, content owners, images, etc. contained thereon. Web site 20 also may be a private site, which is only assessable to users via the watermarked CD. Copying the website URL (or link) preferably will not enable user access to the private web site since the link is enabled by a central routing system (e.g., router 16) that receives the watermark ID from a user computer 14. IP address checking and time stamping are some of the ways to help secure a private web site. Assignee's U.S. patent applications Ser. No. 09/853,835, filed May 10, 2001, and Ser. No. 09/864,084, filed May 22, 2001, disclose still other techniques for securing a private web site. Such techniques may be interchangeable used with the present invention.

A digital watermark can also be used to verify that the CD is authentic (e.g., is not a pirated copy). The watermark can be verified by inspection agents of a company in retail or distribution channels using the linking techniques described above and/or those described in Assignee's U.S. patent application Ser. No. 09/924,402. If an inspection agent finds a CD without a visual design watermark, e.g., when that CD should include a visual design watermark, the agent has a clue to help find the source of this pirated CD. In another example, if a CD label provides instructions to hold the CD's embedded visual design to a web camera to enable the above-described web linking, and nothing happens, then the CD is probably a pirated copy. The CD label can include further instructions in the event of a linking-failure (e.g., upon reading a pirated copy). The instructions can include how to contact the CD or DVD owner or distributor with information that can help trace the origins of the illegal copy.

Similarly, a consumer can verify CD authenticity by testing the linking capabilities of the CD's visual design, e.g., prior to purchasing the CD via a web-enabled store kiosk or hand-held device. Or the consumer can verify authenticity at home after the purchase.

Serialized CDs, discussed above, can be tracked to learn who has purchased and re-purchased the CDs. Or serialization can be used to trace the origin of an illegal copy.

In an alternative embodiment, the visible design itself is used as an identifier instead of a digital watermark. Pattern recognition software is used to detect the visual design. The pattern of the visual design is associated with an identifier, which is used as a substitute for the watermark identifier discussed herein. In still another embodiment, the visual design is mathematically analyzed, e.g., via a hash or fingerprinting algorithm. The resulting hash or fingerprint value is used as the identifier. A hash or fingerprint database can be consulted to determine an action or to obtain additional information associated with the identifier. Hence, the visual design or pit-pattern itself can serve as (or be used to derive) an identifier.

Concluding Remarks

The foregoing are just exemplary implementations of the present invention. It will be recognized that there are a great number of variations on these basic themes. The foregoing illustrates but a few applications of the detailed technology. There are many others.

To provide a comprehensive disclosure without unduly lengthening this specification, the above-mentioned patents and patent applications are hereby incorporated by reference. The particular combinations of elements and features in the above-detailed embodiments are exemplary only; the interchanging and substitution of these teachings with other teachings in this application and the incorporated-by-reference patents/applications are expressly contemplated.

The above-described methods and functionality can be facilitated with computer executable software stored on computer readable media. Such software may be stored and executed on a general-purpose computer, or on a server for distributed use. Also, instead of software, a hardware implementation, or a software-hardware implementation can be used.

In view of the wide variety of embodiments to which the principles and features discussed above can be applied, it should be apparent that the detailed embodiments are illustrative only and should not be taken as limiting the scope of the invention. Rather, I claim as my invention all such modifications as may come within the scope and spirit of the following claims and equivalents thereof.

What is claimed is:

1. A method comprising the steps of:
altering the pit-pattern of a visual design to embed a digital watermark therein; and
applying the embedded visual design to physical media.

2. The method according to claim 1, wherein the physical media comprises one of at least a SACD, CD, DVD, laser disc, mini-disc, and CD2.

3. The method according to claim 1, wherein said applying step comprises pit-signal processing.

4. The method according to claim 1, wherein the digital watermark is imperceptible in comparison to the visual design.

5. The method according to claim 2, wherein the visual design comprises a visual watermark.

6. Media including a plurality of pits, said media comprising:
a visual design formed by the plurality of pits; and
a digital watermark embedded within the visual design.

7. The media according to claim 6, wherein the media comprises one of at least a SACD, CD, DVD, laser disc, mini-disc and CD2.

8. The media according to claim 6, wherein the digital watermark is embedded by varying pit locations of a subset of the plurality of pits.

9. The media according to claim 6, wherein the visual design comprises a visible watermark.

10. The media according to claim 9, further comprising a watermark embedded within data stored on the media.

11. A method of verifying the authenticity of media, wherein authentic media comprises a digital watermark embedded in a visual design formed by pits in the media, said method comprising:
presenting the media to a watermark detector; and
when a watermark is found, linking to content related to the media through information carried by the watermark.

12. The method according to claim 11, further comprising the step of authenticating the media by successfully completing said linking step.

13. The method according to claim 11, wherein the media comprises a digital watermark embedded on a non-data side of the media, and wherein said method comprises the step of detecting the digital watermark on the non-data media side.

14. The method according to claim 13, wherein said non-data side watermark is compared to the watermark embedded in the visual design.

15. A method to identify physical media comprising the steps of:
analyzing an visual pattern on the physical media; and
identifying the physical media through said analyzing step.

16. The method according to claim 15, wherein said analyzing step comprises at least one of pattern recognition, hashing and fingerprinting.

17. The method according to claim 16, wherein said analyzing step determines a value corresponding to the visual pattern and the value is used in said identifying step to identify the physical media.

18. The method according to claim 17, wherein the value is used to index a database comprising information related to the physical media.

19. The method according to claim 17, wherein the physical media comprises at least one of a SACD, CD, DVD, laser disc, mini-disc and CD2.

20. The method according to claim 19, wherein the visual pattern comprises a pattern of pits on a data side of the physical media.
